(19) United States
(12) Patent Application Publication
(10) Pub. No.: US 2020/0019191 A1
(43) Pub. Date: Jan. 16, 2020

(54) METHOD FOR FOLLOWING WEARABLE DEVICE AND ROBOT THEREOF

(71) Applicant: LG ELECTRONICS INC., Seoul (KR)

(72) Inventors: Jiyoon KIM, Seoul (KR); Kyunga KIM, Seoul (KR); Dongwook KIM, Seoul (KR); Hoihan KIM, Seoul (KR); Minhwa BAE, Seoul (KR); Ryoungkyoung LEE, Seoul (KR); Sunmyoung LEE, Seoul (KR); Seonock JEONG, Seoul (KR)

(21) Appl. No.: 16/583,495

(22) Filed: Sep. 26, 2019

(30) Foreign Application Priority Data
Sep. 11, 2019 (KR) 10-2019-0112786

(51) Int. Cl. G05D 1/12; G05D 1/00; G05D 1/10; B64C 39/02; B64D 47/08; G08B 7/06

(52) U.S. Cl. CPC G05D 1/12; G05D 1/0088; G05D 1/101; B64C 39/024; H04B 1/385; G08B 7/06; B64C 2201/027; B64C 2201/12; B64C 2201/141; B64D 47/08

(57) ABSTRACT

An embodiment provides an unmanned flying robot including a communication unit configured to communicate with at least one of a wearable device and a user terminal and receive at least one of state information of a wearer of the wearable device and positional information of the wearable device, a drive unit configured to track the wearable device and adjust a driving altitude of the unmanned flying robot based on the positional information, and a controller configured to control the drive unit so as to track the wearable device based on the positional information and adjust the driving altitude to at least one predetermined altitude based on the state information and an operating method thereof. An embodiment provides a user terminal of tracking a wearable device using an unmanned flying robot.

### CROSS-REFERENCE TO RELATED APPLICATION

This application is based on and claims priority under 35 U.S.C. § 119(a) to Korean Patent Application No. 10-2019-0112786, which was filed on Sep. 11, 2019, in the Korean Intellectual Property Office, the disclosure of which is incorporated herein in its entirety by reference.

### BACKGROUND

### 1. Field

The present disclosure relates to a method of tracking a wearable device and an apparatus thereof.

### 2. Description of the Related Art

An unmanned flying robot is a generic term for unmanned aerial vehicles or uninhabited aerial vehicles (UAVs) taking the form of an airplane or a helicopter, which may be operated and controlled by radio wave guidance without a pilot. Recently, an unmanned flying robot has been increasingly used in various private and commercial fields, such as photographing, unmanned home delivery services, and disaster monitoring, in addition to military uses such as reconnaissance and attacks.

Private and commercial unmanned flying robots may need to be operated in a limited way due to various regulations and the lack of foundations for certifications and legal systems, for example, and it may be difficult for people who use unmanned flying robots to recognize potential dangers or dangers to the public. In particular, indiscriminate use of unmanned flying robots is increasing, for example, collision accidents, flight in security areas, and invasion of privacy.

Many countries are working to improve new regulations, standards, policies, and procedures, for example, with regard to management of unmanned flying robots.

### SUMMARY

With recent developments, wearable devices have been utilized in various fields in the market, and wearers may be able to experience various technologies while carrying wearable devices. Such a wearable device may determine the current state and position of a wearer in real time, and may transmit information about the state of the wearer to various electronic devices around the wearable device. As such, the current state of the wearer may be grasped in real time and appropriate action may be taken as needed.

A user who needs to protect the wearer wearing the wearable device may monitor and grasp the current state and position of the wearer in real time without being accompanied by the wearer. However, the user may have difficulty, for example, in dealing immediately with a sudden situation occurring around the wearer.

The present disclosure provides an apparatus and method of enabling a protector of a wearer wearing a wearable device to take physical measures on a sudden situation occurring to the wearer based on the state and position of the wearer even in the state in which the protector is not accompanied by the wearer.

In order to address the above description, according to one embodiment, there may be provided an unmanned flying robot including a communication unit configured to communicate with at least one of a wearable device and a user terminal and receive at least one of state information of a wearer of the wearable device and positional information of the wearable device, a drive unit configured to track the wearable device and adjust a driving altitude of the unmanned flying robot based on the positional information, and a controller configured to control the drive unit so as to track the wearable device based on the positional information and adjust the driving altitude to at least one predetermined altitude based on the state information.

In order to address the above description, according to another embodiment, there may be provided a method including receiving positional information of a wearable device, receiving state information of a wearer of the wearable device, tracking the wearable device based on the positional information, and adjusting a driving altitude of an unmanned flying robot to at least one predetermined altitude based on at least one of the positional information and the state information.

In order to address the above description, according to a further embodiment, there may be provided a user terminal configured to track a wearable device using an unmanned flying robot, the user terminal including a communication unit configured to communicate with at least one of the wearable device and the unmanned flying robot, and a controller configured to control the communication unit so as to receive notification information when the unmanned flying robot adjusts a driving altitude thereof to at least one predetermined altitude based on at least one of state information of a wearer and positional information of the wearable device received from the wearable device in a process of tracking the wearable device by the unmanned flying robot.

Through various embodiments included herein, even if a user does not operate an electronic device including, for example, a wearable device in real time using a terminal without being accompanied by a wearer wearing the wearable device, the user may grasp the state and position of the wearer in real time and may adaptively control the wearer's behavior based on the state of the wearer and take physical measures on a sudden situation.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 is a perspective view illustrating an unmanned flying robot according to an embodiment of the present disclosure.

FIG. 2 is a block diagram illustrating a control relationship between major components of the unmanned flying robot of FIG. 1.

FIG. 3 is a block diagram illustrating a control relationship between major components of an aviation control system interworked with the unmanned flying robot according to an embodiment.

FIG. 4 is a block diagram illustrating an unmanned flying robot of tracking a wearable device according to an embodiment.

FIG. 5 is a flowchart illustrating a method of tracking a wearable device by an unmanned flying robot according to an embodiment.

FIG. 6 illustrates adjustment of the driving altitude of an unmanned flying robot according to a predetermined condition according to an embodiment.

FIG. 7 is a block diagram illustrating an unmanned flying robot capable of tracking a wearable device based on photographing information according to an embodiment.

FIG. 8 is a flowchart illustrating a method of tracking a wearable device using photographing information by an unmanned flying robot according to an embodiment.

FIG. 9 illustrates one exemplary adjustment of the driving altitude of an unmanned flying robot according to a predetermined condition according to an embodiment.

FIG. 10 illustrates another exemplary adjustment of the driving altitude of an unmanned flying robot according to a predetermined condition according to an embodiment.

FIG. 11 is a flowchart illustrating a method of adjusting the driving altitude of an unmanned flying robot based on whether at least one of positional information and state information satisfies at least one predetermined condition according to an embodiment.

FIG. 12 illustrates adjustment of the driving altitude of an unmanned flying robot based on whether at least one of positional information and state information satisfies at least one predetermined condition according to an embodiment.

FIG. 13 illustrates a communication procedure between a wearable device, an unmanned flying robot, and a user terminal according to an embodiment.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, embodiments of the present disclosure may be described in detail with reference to the drawings so that those skilled in the art can easily carry out the present disclosure. The present disclosure may be embodied in many different forms and may not be limited to the embodiments described herein.

With respect to constituent elements used in the following description, suffixes “module” and “unit” may be given or mingled with each other only in consideration of ease in the preparation of the specification, and may not have or serve as different meanings.

In order to clearly describe the present disclosure, elements having no connection with the description may be omitted, and the same or extremely similar elements may be designated by the same reference numerals throughout the specification. In addition, some embodiments of the present disclosure may be described in detail with reference to exemplary drawings. When adding reference numerals to constituent elements of the respective drawings, it should be noted that the same or similar elements may be denoted by the same reference numerals even though they are depicted in different drawings. In addition, in the following description of the present disclosure, a detailed description of known functions and configurations incorporated herein may be omitted when it may make the subject matter of the present disclosure rather unclear.

In addition, it may be understood that the terms first, second, A, B, (a), and (b), for example, may be used herein to describe various elements according to the embodiments of the present disclosure. These terms may only be used to distinguish one element from another element and, thus, are not intended to limit the essence, order, sequence, or number of elements. It may be understood that, when any element is referred to as being “connected to” “coupled to”, or “joined to” another element, it may be directly on, connected to or coupled to the other element or intervening elements may be present.

It may be further understood that the terms “comprises” “comprising” “includes” and/or “including” when used in this specification, may specify the presence of stated features, integers, steps, operations, elements, and/or components, but may not preclude the presence or addition of one or more other features, integers, steps, operations, elements, and/or components.

In addition, for convenience of description, the present disclosure may be embodied by subdividing constituent elements, but these constituent elements may be embodied in a single device or module, or one constituent element may be divided into multiple devices or modules.

Hereinafter, various embodiments of the present disclosure may be described with reference to the accompanying drawings.

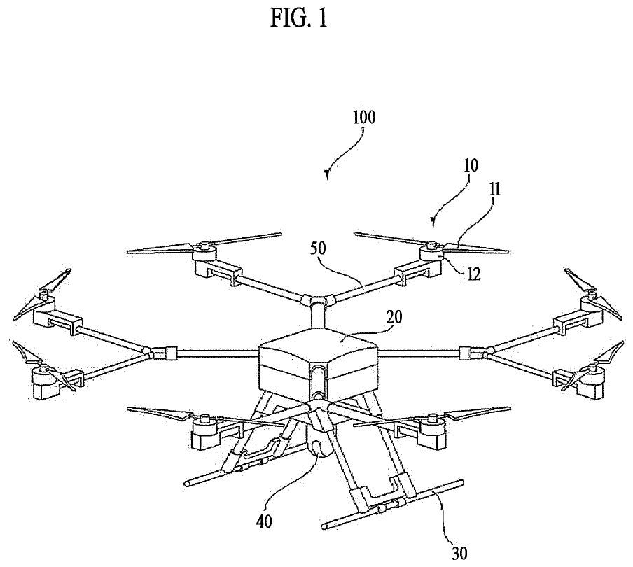

FIG. 1 is a perspective view illustrating an unmanned flying robot according to an embodiment of the present disclosure.

First, the unmanned flying robot 100 may be manually operated by an operator who is on the ground, or may be automatically controlled by a preset flight program, to perform unmanned flight. As illustrated in FIG. 1, unmanned flying robot 100 may be configured to include a main body 20, a horizontal and vertical movement propulsion device 10, and landing legs 30.

Main body 20 may be a body portion to which a module such as an operation unit 40 is mounted.

Horizontal and vertical movement propulsion device 10 may be composed of one or more propellers 11 provided vertically on main body 20. According to an embodiment of the present disclosure, horizontal and vertical movement propulsion device 10 may be composed of multiple propellers 11 and motors 12 spaced apart from each other. Alternatively, horizontal and vertical movement propulsion device 10 may have a configuration of an air-injection-type propeller, instead of propellers 11.

Multiple propeller support units 50 may be radially formed on main body 20. Each propeller support unit 50 may be equipped with motor 12, and each motor 12 may be equipped with propeller 11.

Multiple propellers 11 may be disposed symmetrically about the center of main body 20. The rotation directions of motors 12 may be determined such that multiple propellers 11 are rotated in combined clockwise and counterclockwise directions. A pair of propellers 11, disposed symmetrically about the center of main body 20, may be set to have the same rotation direction (e.g., the clockwise direction). Another pair of propellers 11 may be set to have an opposite rotation direction (e.g., the counterclockwise direction).

Landing legs 30 may be spaced apart from each other on the bottom surface of main body 20. A shock absorbing support member (not illustrated) may be mounted on a lower portion of each landing leg 30 to minimize shocks caused by a collision with the ground when unmanned flying robot 100 lands. Needless to say, unmanned flying robot 100 may have any of various aerial vehicle configurations other than the above-described configuration.

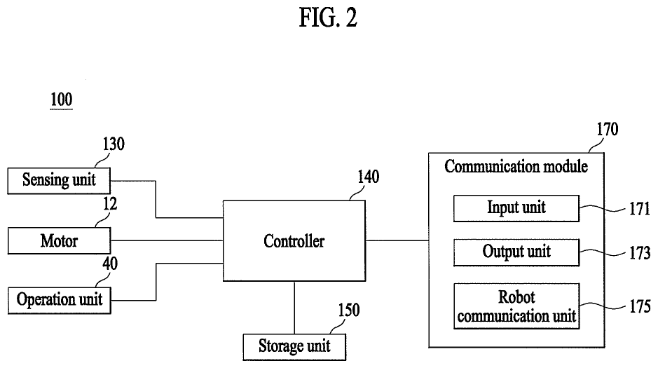

FIG. 2 is a block diagram illustrating a control relationship between major components of the unmanned flying robot of FIG. 1.

Referring to FIG. 2, unmanned flying robot 100 may measure the flight state thereof using various sensors for stable flight. Unmanned flying robot 100 may include a sensing unit 130 including at least one sensor.

The flight state of unmanned flying robot 100 may be defined as a rotational state and a translational state.

The rotational state may be defined by “yaw”, “pitch”, and “roll”, and the translational state may be defined by “longitude”, “latitude”, “altitude”, and “speed”.

Here, “roll”, “pitch”, and “yaw” may be called the Euler angles, and may be rotated angles of three x-, y-, and z-axes of airplane body frame coordinates with respect to specific coordinates, e.g., three N-, E-, and D-axes of NED coordinates. When the front side of an airplane rotates leftward and rightward about the z-axis of body frame coordinates, the x-axis of body frame coordinates has an angle with respect to the N-axis of NED coordinates and this angle is referred to as “yaw (ψ)”. When the front side of the airplane rotates upward and downward about the y-axis that is directed to the right, the z-axis of body frame coordinates has an angle with respect to the D-axis of NED coordinates and this angle is referred to as “pitch (θ)”. When the fuselage of the airplane is tilted leftward and rightward about the x-axis that is directed to the front, the y-axis of body frame coordinates has an angle with respect to the E-axis of NED coordinates and this angle is referred to as “roll (ϕ)”.

Unmanned flying robot 100 may use a three-axis gyroscope, a three-axis accelerometer, and a three-axis magnetometer to measure the rotational state, and may use a GPS sensor and a barometric pressure sensor to measure the translational state.

Sensing unit 130 of the present disclosure may include at least one of a gyroscope, an accelerometer, a magnetometer, a GPS sensor, a camera sensor, and a barometric pressure sensor. Here, the gyroscope and the accelerometer may measure the rotated state and the accelerated state of body frame coordinates of unmanned flying robot 100 with respect to earth centered inertial coordinates, and may be manufactured as a single chip called an inertial measurement unit (IMU) using a micro-electro-mechanical system (MEMS) semiconductor process technology. The IMU chip may include therein a microcontroller which converts measurements of earth centered inertial coordinates from the gyroscope and the accelerometer into local coordinates such as north-east-down (NED) coordinates used by a GPS.

The gyroscope may measure angular velocities of three x-, y-, and z-axes of body frame coordinates of unmanned flying robot 100 rotated with respect to earth centered inertial coordinates and then calculate converted fixed coordinate values Wx.gyro, Wy.gyro, and Wz.gyro, and may convert these values into the Euler angles ϕgyro, θgyro, and ψgyro using a linear differential equation.

The accelerometer may measure accelerations of three x-, y-, and z-axes of body frame coordinates of unmanned flying robot 100 with respect to earth centered inertial coordinates and then calculate converted fixed coordinate values fx.acc, fy.acc, and fz.acc, and may convert these values into the “roll ϕacc” and the “pitch θacc”, which are used to remove bias errors included in the “roll ϕgyro” and the “pitch θgyro” calculated using measurements of the gyroscope.

The magnetometer may measure orientations of three x-, y-, and z-axes of body frame coordinates of unmanned flying robot 100 with respect to the magnetic north, and may calculate the “yaw” value of body frame coordinates with respect to NED coordinates using the measurements.

The GPS sensor may calculate the translational state of unmanned flying robot 100 on NED coordinates. i.e., the latitude Pn.GPS, the longitude Pe.GPS, the altitude hMSL.GPS, the latitude velocity Vn.GPS, the longitude velocity Ve.GPS, and the altitude velocity Vd.GPS using signals received from GPS satellites. Here, “MSL” means a mean sea level.

The barometric pressure sensor may measure the altitude hALP.baro of unmanned flying robot 100. Here, “ALP” means an air level pressure. The barometric pressure sensor may calculate the current altitude of unmanned flying robot 100 from a takeoff point by comparing the atmospheric pressure at the time of takeoff with the atmospheric pressure at the current flight altitude.

The camera sensor may include an image sensor (e.g., a CMOS image sensor) configured to include at least one optical lens and multiple photodiodes (e.g., pixels) on which an image is formed by light that has passed through the optical lens, and a digital signal processor (DSP) configured to form an image based on signals output from the photodiodes. The digital signal processor may form not only a still image but also a moving image composed of still image frames.

Unmanned flying robot 100 may include a communication module 170 for input or reception of information and output or transmission of information. Communication module 170 may include a robot communication unit 175 for transmission and reception of information to and from other external devices. Communication module 170 may include an input unit 171 for input of information. Communication module 170 may include an output unit 173 for output of information. Needless to say, output unit 173 may be omitted in unmanned flying robot 100 and may be formed in a terminal 300. Communication module 170 may include a hardware component such as a transceiver, a communication interface, etc.

In one example, unmanned flying robot 100 may directly receive information from input unit 171. In another example, unmanned flying robot 100 may receive information, input to separate terminal 300 or a separate server 200, through robot communication unit 175.

In one example, unmanned flying robot 100 may directly output information to output unit 173. In another example, unmanned flying robot 100 may transmit information to separate terminal 300 through robot communication unit 175, so that terminal 300 may output the information.

Robot communication unit 175 may be provided to communicate with external server 200 and terminal 300, for example. Robot communication unit 175 may receive information input from terminal 300 such as a smart phone or a computer. Robot communication unit 175 may transmit, to terminal 300, information to be output. Terminal 300 may output the information received from robot communication unit 175.

Robot communication unit 175 may receive various command signals from terminal 300 and/or server 200. Robot communication unit 175 may receive area information, a driving route, and a driving command for driving of unmanned flying robot 100 from terminal 300 and/or server 200. Here, the area information may include information on a flight restricted area A and information on an access restriction distance.

Input unit 171 may receive power-on and power-off commands and various other commands. Input unit 171 may receive the area information. Input unit 171 may also receive object information. Input unit 171 may include various buttons, a touch pad, or a microphone, for example.

Output unit 173 may inform a user of various types of information. Output unit 173 may include a speaker and/or a display. Output unit 173 may output information on an object detected during driving. Output unit 173 may output identification information of the detected object. Output unit 173 may output positional information of the detected object.

Unmanned flying robot 100 may include a controller 140 which performs processing and determination of various types of information such as mapping and/or recognition of the current position. Controller 140 may control the overall operation of unmanned flying robot 100 via control of various components constituting unmanned flying robot 100.

Controller 140 may receive and process information from communication module 170. Controller 140 may receive and process information from input unit 171. Controller 140 may receive and process information from robot communication unit 175. Controller 140 may receive and process sensing information from sensing unit 130.

Controller 140 may control driving of motor 12. Controller 140 may control an operation of operation unit 40.

Unmanned flying robot 100 may include a storage unit 150 which stores various data. Storage unit 150 may record various types of information necessary for control of unmanned flying robot 100, and may include a volatile or nonvolatile recording medium.

Storage unit 150 may store a map about a driving area. The map may be input by external terminal 300 which may exchange information with unmanned flying robot 100 through robot communication unit 175, or may be generated by self-learning of unmanned flying robot 100. In the former case, external terminal 300 may include, for example, a remote controller, a PDA, a laptop computer, a smart phone, or a tablet, which is equipped with a map setting application.

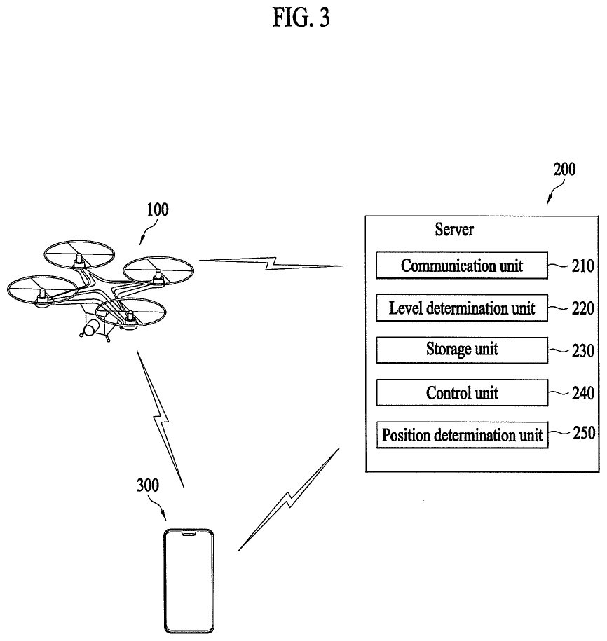

FIG. 3 is a block diagram illustrating a control relationship between major components of an aviation control system interworked with the unmanned flying robot according to an embodiment.

Referring to FIG. 3, the aviation control system according to an embodiment of the present disclosure may include unmanned flying robot 100 and server 200, or may include unmanned flying robot 100, terminal 300, and server 200. Unmanned flying robot 100, terminal 300, and server 200 may be connected to each other by a wireless communication method.

The wireless communication method may be, for example, a global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), or long term evolution-advanced (LTE-A) method.

The wireless communication method may use a wireless internet technology. Examples of the wireless Internet technology may include a wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and 5G technology. In particular, faster response may be possible via transmission and reception of data using a 5G communication network.

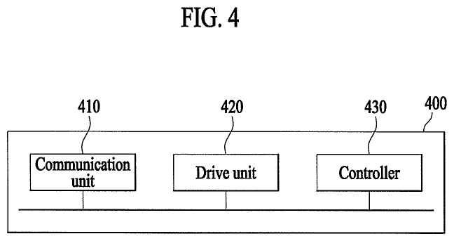

FIG. 4 is a block diagram illustrating an unmanned flying robot of tracking a wearable device according to an embodiment. The unmanned flying robot 400 of FIG. 4 may correspond to the unmanned flying robot described with reference to FIGS. 1 to 3.

According to an embodiment, unmanned flying robot 400 may include a communication unit 410 configured to communicate with at least one of a wearable device and a user terminal so as to receive at least one of state information of a wearer of the wearable device and positional information of the wearable device, a drive unit 420 configured to track the wearable device and adjust the driving altitude of unmanned flying robot 400 based on the positional information, and a controller 430 configured to control the drive unit so as to track the wearable device based on the positional information and adjust the driving altitude to at least one predetermined altitude based on the state information. According to an embodiment, a drive unit 420 may include at least one hardware device (e.g., motor 12), to provide drive force for unmanned flying robot 400.

According to an embodiment, communication unit 410 may transmit and receive data to and from other electronic devices (e.g., a wearable device, a user terminal, and a server) using wired and wireless communication technologies. For example, communication unit 410 may transmit and receive various types of information, such as positional information of external devices and the wearable device, state information indicating the state of the wearer of the wearable device, photographing information indicating the appearance of the wearer of the wearable device, information indicating the state of unmanned flying robot 400, and predetermined notification information. The communication technologies used by communication unit 410 may include GSM, CDMA, LTE, 5G, WLAN, Wi-Fi, Bluetooth, RFID, infrared communication, ZigBee, and NFC, for example. According to an embodiment, communication unit 410 of FIG. 4 may correspond to robot communication unit 175 described above with reference to FIG. 2.

According to an embodiment, drive unit 420 may impart a predetermined movement to unmanned flying robot 400. Drive unit 420 may correspond to horizontal and vertical movement propulsion device 10 described above with reference to FIGS. 1 and 2.

According to an embodiment, controller 430 of unmanned flying robot 400 may control communication unit 410 and drive unit 420 to realize various embodiments of the present disclosure. Various embodiments of the present disclosure, which may be realized by controller 430, will be described below.

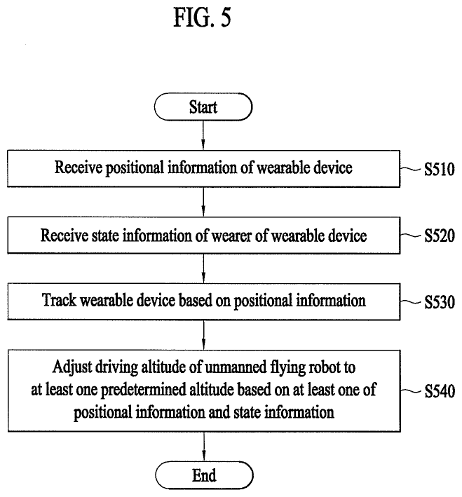

FIG. 5 is a flowchart illustrating a method of tracking a wearable device by the unmanned flying robot according to an embodiment.

In step S510, unmanned flying robot 400 may receive positional information of a wearable device. According to an embodiment, the positional information of the wearable device may be information indicating the current position of the wearable device such as a GPS signal. According to an embodiment, the positional information of the wearable device may be directly received from the wearable device, or may be received from another electronic device (e.g., a server or a user terminal which may receive the positional information from the wearable device) interworked with unmanned flying robot 400. Hereinafter, for convenience of description, it is assumed that the positional information is received from the wearable device.

According to an embodiment, unmanned flying robot 400, which has received the positional information, may determine the current position of the wearable device based on the positional information. The determined position of the wearable deice may then be used to track the wearable device.

In step S520, unmanned flying robot 400 may receive state information of the wearer of the wearable device. According to an embodiment, the wearable device may acquire various types of information indicating the state of the wearer.

According to an embodiment, the wearable device may include sensors such as a heart rate measuring sensor, a blood pressure measuring sensor, and a blood sugar sensor for determining the health state of the wearer, and unmanned flying robot 400 may receive, as the state information of the wearer, information indicating the health state acquired through the sensors.

According to an embodiment, the wearable device may measure a sound generated around the wearer, and unmanned flying robot 400 may receive the state information of the wearer indicating the current state of the wearer determined based on the measured sound. According to an embodiment, the measured sound may be a sound generated in an environment around the wearer, or may be the wearer's voice. According to an embodiment, the state information may indicate whether the current state of the wearer shows an abnormal sign based on voice recognition, and unmanned flying robot 400, which has received the state information, may determine the current state of the wearer or may share the state information with other electronic devices.

According to an embodiment, the wearable device may receive various types of state information according to kinds of the wearer. According to an embodiment, there may be various wearers including a general person, a patient, an infant, and a pet, for example. According to an embodiment, in the case of a pet, different types of state information may be received, compared to the case of a human being. According to an embodiment, when the pet wears the wearable device, unmanned flying robot 400 may receive state information indicating abnormal signs of the pet (e.g., howling, crying, or wheezing sound, sudden movement, or excessive touches with other pets).

According to an embodiment, the state information may be information indicating whether the wearer is located within a predetermined distance from the boundary of a predetermined area by comparing information on the predetermined area with the current position. According to an embodiment, the status information may be information indicating whether the wearer is located in at least one area (e.g., a first area within 20 meters from the boundary or a second area within 10 meters from the boundary) divided according to a distance from the boundary of the predetermined area.

In step S530, unmanned flying robot 400 may track the wearable device based on the positional information received in step S510. According to an embodiment, unmanned flying robot 400, which has received the positional information, may track the wearable device by determining the current position of the wearable device based on the received positional information. According to an embodiment, unmanned flying robot 400 may further include a GPS sensor for determining the current position thereof. Unmanned flying robot 400 may track the wearable device by moving to the position of the wearable device using the position of unmanned flying robot 400 and the positional information of the wearable device.

In step S540, according to an embodiment, unmanned flying robot 400 may adjust the driving altitude thereof to at least one predetermined altitude based on at least one of the positional information and the state information.

According to an embodiment, unmanned flying robot 400 may adjust the driving altitude thereof to at least one predetermined altitude. According to an embodiment, the at least one predetermined altitude may be associated with at least one of the positional information and the state information. According to an embodiment, unmanned flying robot 400 may determine whether at least one of the positional information and the state information satisfies at least one predetermined condition. According to an embodiment, the at least one predetermined condition may correspond to the at least one predetermined altitude. That is, unmanned flying robot 400 may adjust the driving altitude thereof according to each condition by setting the driving altitude to a predetermined altitude corresponding to the predetermined condition. A process of adjusting the driving altitude of unmanned flying robot 400 to at least one predetermined altitude will be described below through various embodiments.

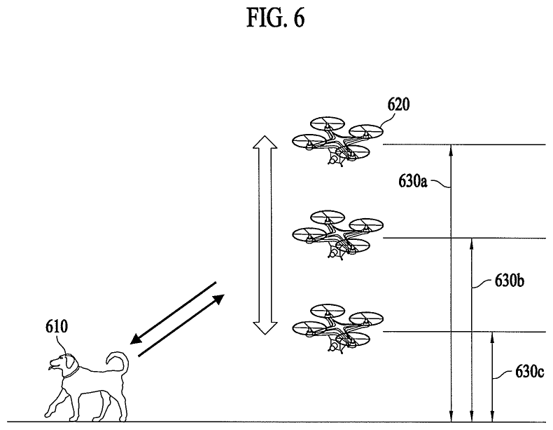

FIG. 6 illustrates adjustment of the driving altitude of an unmanned flying robot according to a predetermined condition according to an embodiment.

According to an embodiment, the unmanned flying robot 620 may receive positional information and state information from a wearable device 610, and may adjust the driving altitude thereof to at least one predetermined altitude based on at least one of the positional information and the state information.

Referring to FIG. 6, unmanned flying robot 620 may adjust the driving altitude thereof to one of three predetermined altitudes 630a, 630b, and 630c based on a determination in that which of the three predetermined altitudes satisfies a condition associated with at least one of the positional information and the state information.

According to an embodiment, when it is determined that the positional information and the state information satisfy a normal condition, unmanned flying robot 620 may set the driving altitude to medium altitude 630b.

According to an embodiment, when it is determined that at least one of the positional information and the state information meets a condition that may be regarded as an abnormal sign, unmanned flying robot 620 may set the driving altitude to low altitude 630c to approach the wearer wearing wearable device 610.

According to an embodiment, when at least one of the positional information and the state information is not received or when it is determined that inappropriate information is received, unmanned flying robot 620 may set the driving altitude to high altitude 630a to move to a higher place.

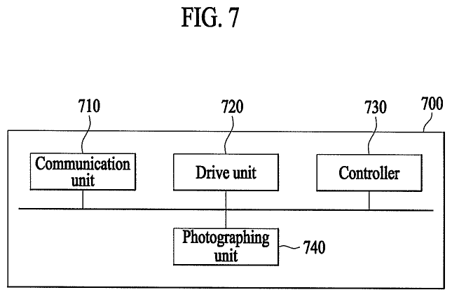

FIG. 7 is a block diagram illustrating an unmanned flying robot capable of tracking a wearable device based on photographing information according to an embodiment. The unmanned flying robot 700 of FIG. 7 may further include a photographing unit 740, in addition to the components of unmanned flying robot 400 of FIG. 4.

According to an embodiment, photographing unit 740 may correspond to the camera sensor included in sensing unit 130 of FIG. 2. According to an embodiment, photographing unit 740 may include any of various cameras such as an RGB camera, an infrared camera, or a thermal imaging camera.

According to an embodiment, unmanned flying robot 700 may track the wearable device using photographing information acquired through photographing unit 740, and may share the photographing information with terminals of other users who are interested in the state of the wearer. A detailed description thereof will be described below.

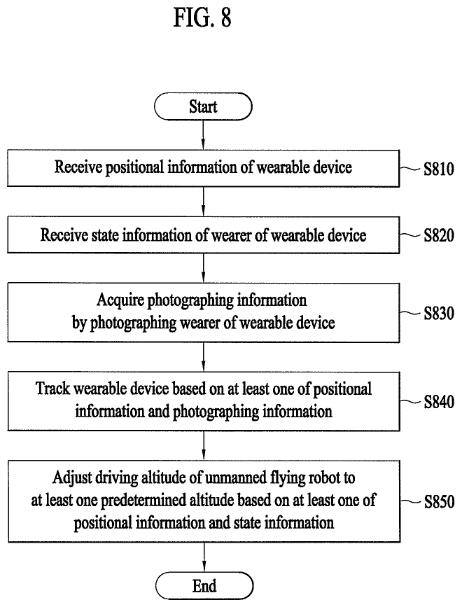

FIG. 8 is a flowchart illustrating a method of tracking a wearable device using photographing information by an unmanned flying robot according to an embodiment. Features of steps S810, S820 and S850 of FIG. 8 may be the same as or similar to features of steps S510, S520, and S540 of FIG. 5 and thus, a detailed description thereof will be omitted.

In step S830, according to an embodiment, unmanned flying robot 700 may acquire photographing information by photographing the wearer of the wearable device through photographing unit 740. According to an embodiment, the acquired photographing information may be a dynamic image representing the real time appearance of the wearer of the wearable device, or may be a static image photographed at a predetermined time interval or photographed by triggering in a predetermined situation.

In step S840, according to an embodiment, unmanned flying robot 700 may track the wearable device based on at least one of photographing information and positional information. According to an embodiment, unmanned flying robot 700 may not only track the wearable device based on positional information indicating the position of the wearable device, but also track the wearable device based on the appearance of the wearer of the wearable device recognized based on the photographing information.

According to an embodiment, various object detection algorithms and object tracking algorithms, which may be easily implemented by those skilled in the image processing art, may be used as a technology of recognizing the wearer of the wearable device based on photographing information. According to an embodiment, such an algorithm may include an algorithm for detecting an object through not only face recognition but also machine learning and deep learning. Accordingly, even when the wearer is a pet, unmanned flying robot 700 may detect and track the pet wearing the wearable device based on the acquired photographing information.

In step S850, according to an embodiment, unmanned flying robot 700 may adjust the driving altitude thereof to at least one predetermined altitude based on at least one of positional information and state information. According to an embodiment, the positional information and the state information may be processed based on the photographing information acquired in step S830. According to an embodiment, in an environment in which the unmanned flying robot may not receive a GPS signal indicating the current position of the wearable device, the current position may be determined based on the photographing information. According to an embodiment, the state information indicating whether the wearer shows an abnormal sign, whether a sudden situation has occurred, or whether the wearer is out of a predetermined area may be determined based on photographing information of the wearer of the wearable device. That is, the driving altitude of unmanned flying robot 700 may be adjusted not only based on at least one of positional information and state information but also based on photographing information.

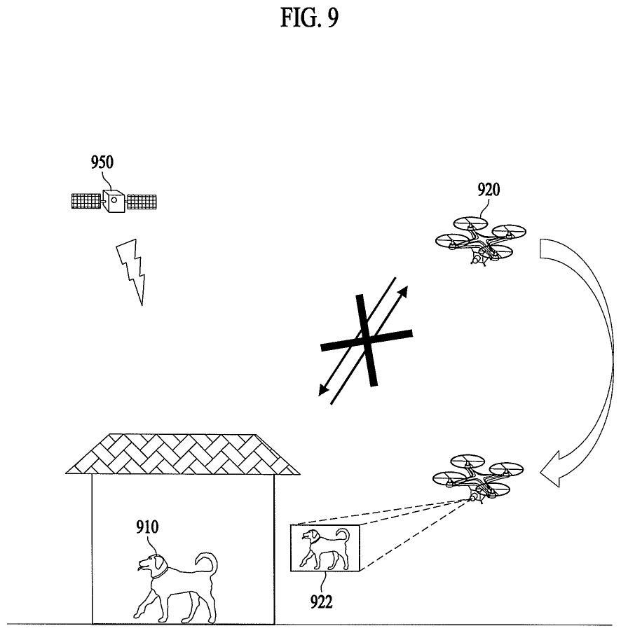

FIG. 9 illustrates one exemplary adjustment of the driving altitude of an unmanned flying robot according to a predetermined condition according to an embodiment.

According to an embodiment, a wearable device 910 may determine the current position thereof based on GPS information acquired through a GPS satellite 950, and positional information indicating the current position of wearable device 910 may be transmitted to the unmanned flying robot 920.

According to an embodiment, unmanned flying robot 920 may not receive accurate positional information when wearable device 910 is located in a place where wearable device 910 may not receive a GPS signal from GPS satellite 950 (e.g., inside the building, under the roof, in the basement, or under the tree). According to an embodiment, when it is determined that positional information may not be received or that incorrect positional information is received, unmanned flying robot 920 may adjust the driving altitude thereof and may acquire photographing information 922 through photographing unit 740. According to an embodiment, when the wearer enters the building and thus, unmanned flying robot 920 may not receive positional information of the wearable device, unmanned flying robot 920 may lower the driving altitude thereof to an altitude at which photographing is possible through photographing unit 740 to acquire photographing information 922. According to an embodiment, the altitude at which photographing information is acquired may be a predetermined altitude (e.g., the altitude of 1 meter from the ground), or may be any of various altitudes that may be adapted to places, such as a height to which unmanned flying robot 920 is accessible, determined based on photographing information 922 acquired through photographing unit 740.

According to an embodiment, acquired photographing information 922 may be transmitted to a user terminal and thus, a user may check the current appearance of the wearer through a display.

According to an embodiment, when unmanned flying robot 920 tries to adjust the driving altitude thereof since unmanned flying robot has failed to receive positional information, unmanned flying robot 920 may transmit notification information to the user terminal, and may also transmit, to the user terminal, information on the current position of unmanned flying robot 920 received during photographing as well as acquired shooting information 922. Thereby, the user may receive a notification indicating that the wearer of wearable device 910 currently enters a location where reception of a GPS signal is impossible, and may also check the current position and the current appearance of the wearer through a display.

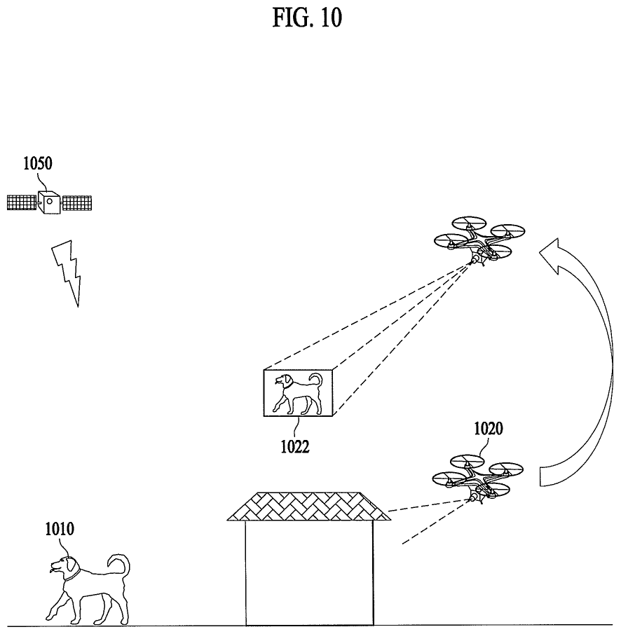

FIG. 10 illustrates another exemplary adjustment of the driving altitude of an unmanned flying robot according to a predetermined condition according to an embodiment.

According to an embodiment, the unmanned flying robot 1020 may receive or acquire positional information, state information, and photographing information on a wearable device 1010 to track wearable device 1010, and may provide the acquired information to a user terminal. According to an embodiment, when unmanned flying robot 1020 fails to receive or acquire at least one of positional information, state information, and photographing information, unmanned flying robot 1020 may adjust the driving altitude thereof to a predetermined altitude.

Referring to FIG. 10, according to an embodiment, when it is determined that a wearer of wearable device 1010 moves to a place where photographing by unmanned flying robot 1020 is impossible (e.g., behind an obstacle) in a process of acquiring photographing information 1022 and thus, photographing information 1022 on the wearer is no longer acquired, unmanned flying robot 1020 may change the driving altitude thereof to a predetermined altitude to move to a location where photographing information 1022 may be obtained even if unmanned flying robot 1020 is under an environment in which it may receive a GPS signal from a GPS satellite 1050 and thus, may receive positional information. According to an embodiment, when unmanned flying robot 1020 has failed to acquire photographing information 1022 in an environment in which it may receive positional information and thus, tries to adjust the driving altitude thereof, unmanned flying robot 1020 may adjust the driving altitude to a predetermined altitude (e.g., the altitude of 5 meters higher than the current altitude) or an altitude at which unmanned flying robot 1020 may recognize the wearer.

According to an embodiment, when unmanned flying robot 1020 has failed to acquire photographing information 1022 and thus, adjusts the driving altitude thereof, unmanned flying robot 1020 may transmit notification information to the user terminal. When it becomes possible to photograph the wearer at the adjusted altitude, unmanned flying robot 1020 may transmit, to the user terminal, notification information indicating that unmanned flying robot 1020 may again recognize the wearer.

According to an embodiment, when photographing information 1022 is acquired via adjustment of the driving altitude, photographing information 1022 acquired before and after adjustment of the driving altitude and information on the current position of unmanned flying robot 1020 received during photographing may be transmitted to the user terminal.

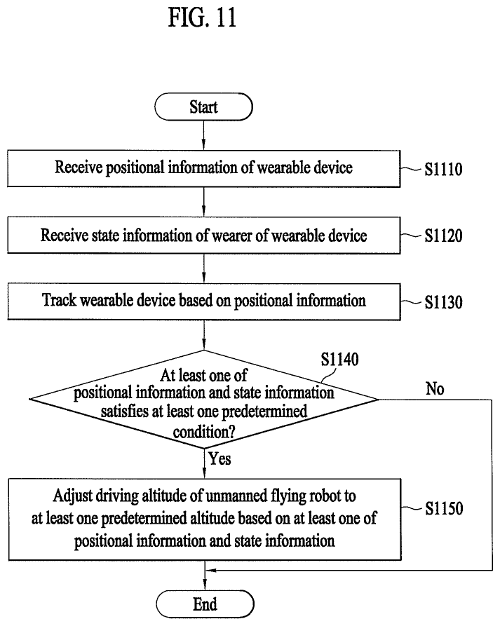

FIG. 11 is a flowchart illustrating a method of adjusting the driving altitude of an unmanned flying robot based on whether at least one of positional information and state information satisfies at least one predetermined condition according to an embodiment. Features of steps S1110, S1120, S1130, and S1150 of FIG. 11 may be the same as or similar to features of steps S510, S520, S530, and S540 of FIG. 5, and thus, a detailed description thereof will be omitted.

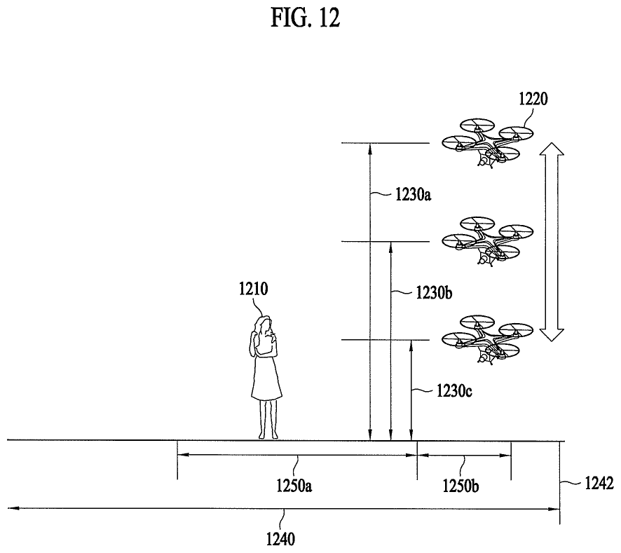

In step S1140, according to an embodiment, unmanned flying robot 400 may determine whether at least one of positional information and state information satisfies at least one predetermined condition. According to an embodiment, the at least one predetermined condition may be a condition associated with at least one of the positional information and the state information. Features of the present disclosure related to the predetermined condition will be described below with reference to FIG. 12

FIG. 12 illustrates adjustment of the driving altitude of an unmanned flying robot based on whether at least one of positional information and state information satisfies at least one predetermined condition according to an embodiment.

According to an embodiment, at least one predetermined condition may be associated with whether a wearer 1210 is located in at least one area spaced apart from a boundary 1242 of a preset area 1240 by a predetermined distance. According to an embodiment, the current position of wearer 1210 wearing a wearable device may be determined from a GPS signal received by the wearable device. According to an embodiment, at least one predetermined condition may include whether positional information indicates that the wearer is located in a first area 1250a from boundary 1242 of preset area 1240 by a predetermined distance and whether positional information indicates that the wearer is located in a second area 1250b closer to boundary 1242 than the first area.

According to an embodiment, preset area 1240 may be an area preset by a user, and information on preset area 1240 may be received from an external electronic device such as a user terminal or a server.

According to an embodiment, preset area 1240 may include, for example, a predetermined movement route, a predetermined partitioned place, and an area within a predetermined radius, and may be preset by the user.

According to an embodiment, the unmanned flying robot 1220 may determine, based on positional information of the wearable device, whether wearer 1210 is included in first area 1250a as a predetermined condition. According to an embodiment, when it is determined that wearer 1210 is included in first area 1250a, unmanned flying robot 1220 may adjust the driving altitude thereof to a first altitude 1230b, which is one of predetermined altitudes, different from a current driving altitude 1230a. According to an embodiment, first altitude 1230b may be lower than current driving altitude 1230a.

According to an embodiment, unmanned flying robot 1220 may determine, based on positional information of the wearable device, whether wearer 1210 is included in second area 1250b closer to boundary 1242 of preset area 1240 than first area 1250a as a predetermined condition. According to an embodiment, when it is determined that wearer 1210 is included in second area 1250b, unmanned flying robot 1220 may adjust the driving altitude thereof to a second driving altitude 1230c lower than first altitude 1230b. According to an embodiment, by adjusting the driving altitude to second altitude 1230c as the wearable device approaches second area 1250b closer to boundary 1242 of preset area 1240, unmanned flying robot 1220 may visually inform the wearer of that the wearer approaches the vicinity of boundary 1242 and thus, may help wearer 1210 to not cross boundary 1242.

According to an embodiment, the state information may include, for example, the movement direction and the movement speed of wearer 1210 of the wearable device.

According to an embodiment, when it is determined that wearer 1210 moves toward boundary 1242 and is included in first area 1250a, unmanned flying robot 1220 may adjust the driving altitude to first altitude 1230b, which is one of predetermined altitudes, different from current driving altitude 1230a. According to an embodiment, when wearer 1210 is included in first area 1250a but moves away from boundary 1242, unmanned flying robot 1220 may remain at current driving altitude 1230a without adjusting the driving altitude thereof. According to an embodiment, when wearer 1210 is included in first area 1250a and moves toward boundary 1242 and then moves away from boundary 1242, unmanned flying robot 1220 may adjust the driving altitude from current driving altitude 1230a to first altitude 1230b and then return to original driving altitude 1230a.

According to an embodiment, when it is determined that wearer 1210 is included in first area 1250a and moves toward boundary 1242 and the movement speed of wearer 1210 is equal to or greater than a predetermined threshold speed, unmanned flying robot 1220 may adjust the driving altitude to a lower altitude (e.g., second altitude 1230c) than first altitude 1230b, which is a predetermined altitude, despite the fact that wearer 1210 is included in first area 1250a.

In this way, unmanned flying robot 1220 may adaptively adjust the driving altitude thereof by additionally considering not only where wearer 1210 is located but also the current state of wearer 1210.

According to an embodiment, unmanned flying robot 1220 may move in a horizontal direction based on the movement direction and the movement speed of wearer 1210 of the wearable device while adjusting the driving altitude thereof.

It is to be understood that FIG. 12 is given by way of example for explaining that unmanned flying robot 1220 may adjust the driving altitude thereof by determining whether the current position and the current state of wearer 1210 satisfies a predetermined condition and therefore, the present disclosure does not need to be interpreted as being limited to the above-described embodiment of FIG. 12 and may be realized in various forms within the scope of the feature that the driving altitude of the unmanned flying robot is adjusted when it is determined that at least one of various combinations of positional information and state information satisfies any of various conditions.

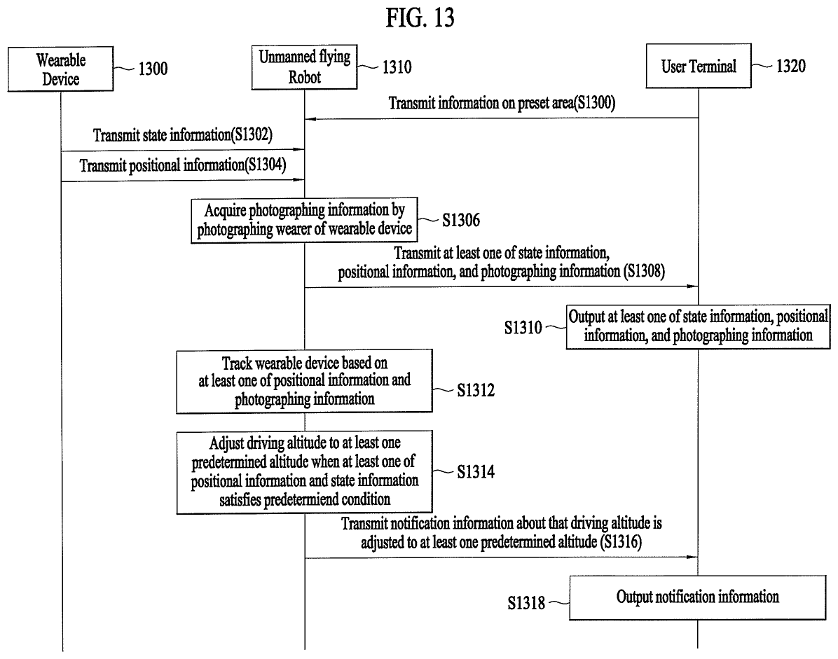

FIG. 13 illustrates a communication procedure between a wearable device, an unmanned flying robot, and a user terminal according to an embodiment.

In step S1300, according to an embodiment, the unmanned flying robot 1310 may receive information on a preset area from the user terminal 1320. According to an embodiment, the preset area may include a predetermined movement route, a predetermined partitioned place, and an area within a predetermined radius, for example, and may be preset through user terminal 1320. According to an embodiment, unmanned flying robot 1310 may receive the preset area information, and may use the received information to track the wearable device 1300 based on at least one of the current position of wearable device 1300 and the current position of unmanned flying robot 1310.

According to an embodiment, unmanned flying robot 1310 may receive state information from wearable device 1300 in step S1302, and may receive positional information from wearable device 1300 in step S1304. According to an embodiment, the state information and the positional information may be received in separate steps, or may be received as combined information in a single step.

In step S1306, according to an embodiment, unmanned flying robot 1310 may acquire photographing information by photographing a wearer of wearable device 1300. Features of step S1306 may be the same as or similar to the features of step S830 of FIG. 8.

In step S1308, according to an embodiment, unmanned flying robot 1310 may transmit at least one of the state information, the positional information, and the photographing information to user terminal 1320. Thereby, in step S1310, according to an embodiment, user terminal 1320 may output at least one of the received state information, positional information, and photographing information. That is, since unmanned flying robot 1310 transmits acquired wearer information to user terminal 1320, user terminal 1320 may output various types of information on the wearer of wearable device 1300. Through this process, the user of user terminal 1320 may receive, from the information output through user terminal 1320, various types of wearer information in real time even when the user is not accompanied by the wearer.

In step S1312, unmanned flying robot 1310 may track wearable device 1300 based on at least one of the positional information and the photographing information. According to an embodiment, unmanned flying robot 1310 may use the positional information indicating the current position of wearable device 1300 in order to track the wearable device, and may track the wearer of wearable device 1300 recognized through the photographing information. According to an embodiment, unmanned flying robot 1310 may perform tracking based on acquired information on the movement direction and the movement speed of wearable device 1300. According to an embodiment, unmanned flying robot 1310 may additionally receive information on the movement direction and the movement speed of wearable device 1300 from wearable device 1300. According to an embodiment, unmanned flying robot 1310 may track wearable device 1300 based on the movement direction and the movement speed of the wearer analyzed based on the photographing information, rather than additionally receiving the information on the movement direction and the movement speed of wearable device 1300.

In step S1314, when at least one of the positional information and the state information satisfies a predetermined condition, unmanned flying robot 1310 may adjust the driving altitude thereof to at least one predetermined altitude corresponding to each condition. According to an embodiment, the predetermined condition may be associated with at least one of the positional information and the state information, and at least one condition may be predetermined through various combinations of the positional information and the state information. Unmanned flying robot 1310 may adjust the driving altitude thereof to at least one predetermined altitude corresponding to each condition according to whether at least one of the positional information and the state information satisfies a predetermined condition. Accordingly, unmanned flying robot 1310 may appropriately intervene in a specific situation of the wearer of wearable device 1300. According to an embodiment, unmanned flying robot 1310 may approach the wearer by lowering the driving altitude thereof so as to be closer to the wearer of the wearable device when at least one of the positional information and the state information satisfies a predetermined condition, and may actively intervene in a situation of the wearer (e.g., move to a location between the wearer and the boundary of a preset area in order to prevent the wearer from leaving the preset area. According to an embodiment, when unmanned flying robot 1310 may not receive positional information or state information from wearable device 1300 or may not photograph the wearer, unmanned flying robot 1310 may lower or raise the altitude thereof from the current driving altitude to appropriately acquire positional information, state information, or photographing information according to various situations of wearable device 1300 (e.g., according to whether unmanned flying robot 1310 may not receive positional information, whether the wearer has disappeared from the viewing angle of the photographing unit, or whether the received positional information or state information is determined to be an error out of an allowable range), and may transmit the acquired information to user terminal 1320.

In step S1316, unmanned flying robot 1310 may transmit notification information to user terminal 1320 to inform user terminal 1320 of that the driving altitude has been adjusted to at least one predetermined altitude. That is, when the driving altitude is adjusted based on a determination in that at least one of the positional information and the state information satisfies a predetermined condition, unmanned flying robot 1310 may notify the user of adjustment of the driving altitude, so that various types of information such as the current state, the current position, and the current appearance of the wearer may be provided to the user. According to an embodiment, the notification information may include at least one of state information, positional information, and photographing information acquired before and after adjustment of the driving altitude, and may further include a notification message indicating that the driving altitude has been adjusted since at least one of the positional information and the state information satisfies a predetermined condition.

In step S1318, user terminal 1320 may provide notification information to the user by outputting the notification information received in step S1316.

The above-described method according to the present disclosure may be provided as a program to be executed in a computer and may be recorded on a computer readable recording medium.

The method according to the present disclosure may be executed via software. When executed via software, the constituent elements of the present disclosure may be code segments that execute required operations. The program or the code segments may be stored in a processor readable medium.

The computer readable recording medium may include all kinds of recording devices in which data is stored in a computer readable manner. Examples of the computer readable recording device may include a ROM, a RAM, a CD-ROM, a DVD-ROM, a DVD-RAM, a magnetic tape, a floppy disc, a hard disc, and an optical data storage device. In addition, the computer readable recording medium may be distributed in a computer device connected thereto via a network so that a computer readable code may be stored and executed in a distribution manner.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An unmanned flying robot comprising:
a communication unit configured to communicate with at least one of a wearable device and a user terminal and receive at least one of state information of a wearer of the wearable device and positional information of the wearable device;
a drive unit configured to track the wearable device and adjust a driving altitude of the unmanned flying robot based on the positional information; and
a controller configured to control the drive unit so as to track the wearable device based on the positional information and adjust the driving altitude to at least one predetermined altitude based on the state information.

2. The unmanned flying robot of claim 1, further comprising a photographing unit configured to photograph the wearer of the wearable device,
wherein the controller is configured to control the drive unit so as to track the wearable device based on at least one of the positional information and photographing information of the wearer acquired through the photographing unit.

3. The unmanned flying robot of claim 2, wherein the controller is configured to control the drive unit so as to adjust the driving altitude to one of the at least one predetermined altitude when reception of the positional information is impossible and track the wearable device based on the photographing information.

4. The unmanned flying robot of claim 1, wherein the controller is configured to control the drive unit so as to adjust the driving altitude to the at least one predetermined altitude corresponding to each condition when at least one of the positional information and the state information satisfies at least one predetermined condition.

5. The unmanned flying robot of claim 4, wherein the controller is configured to control the drive unit so as to adjust the driving altitude to a first altitude associated with a first area when the positional information indicates that the wearable device is located in the first area spaced apart from a boundary of a preset area by a predetermined distance and adjust the driving altitude to a second altitude lower than the first altitude when the positional information indicates that the wearable device is located in a second area closer to the boundary than the first area.

6. The unmanned flying robot of claim 1, wherein the controller is configured to control the drive unit so as to approach the wearable device when reception of the state information is impossible.

7. The unmanned flying robot of claim 1, wherein the controller is configured to control the communication unit so as to transmit, to the user terminal, at least one of the positional information, the state information, and photographing information acquired by photographing the wearer.

8. The unmanned flying robot of claim 1, wherein the controller is configured to control the communication unit so as to transmit notification information to the user terminal when reception of at least one of the positional information and the state information is impossible or when photographing of the wearer is impossible.

9. A method comprising:
receiving positional information of a wearable device;
receiving state information of a wearer of the wearable device;
tracking the wearable device based on the positional information; and
adjusting a driving altitude of an unmanned flying robot to at least one predetermined altitude based on at least one of the positional information and the state information.

10. The method of claim 9, further comprising photographing the wearer of the wearable device,
wherein the tracking includes tracking the wearer based on at least one of the positional information and photographing information acquired via the photographing.

11. The method of claim 10, wherein the tracking the wearable device further includes adjusting the driving altitude to one of the at least one predetermined altitude when reception of the positional information is impossible and tracking the wearable device based on the photographing information.

12. The method of claim 9, wherein the adjusting includes adjusting the driving altitude to the at least one predetermined altitude corresponding to each condition when at least one of the positional information and the state information satisfies at least one predetermined condition.

13. The method of claim 12, wherein the adjusting includes adjusting the driving altitude to a first altitude associated with a first area when the positional information indicates that the wearable device is located in the first area spaced apart from a boundary of a preset area by a predetermined distance and adjusting the driving altitude to a second altitude lower than the first altitude when the positional information indicates that the wearable device is located in a second area closer to the boundary than the first area.

14. The method of claim 9, wherein the tracking further includes approaching the wearable device when reception of the state information is impossible.

15. The method of claim 9, further comprising transmitting, to a user terminal, at least one of the positional information, the state information, and photographing information acquired by photographing the wearer.

16. The method of claim 9, further comprising transmitting a notification message to a user terminal when reception of at least one of the positional information and the state information is impossible or when photographing of the wearer is impossible.

17. A user terminal configured to track a wearable device using an unmanned flying robot, the user terminal comprising:
a communication unit configured to communicate with at least one of the wearable device and the unmanned flying robot; and
a controller configured to control the communication unit so as to receive notification information when the unmanned flying robot adjusts a driving altitude thereof to at least one predetermined altitude based on at least one of state information of a wearer and positional information of the wearable device received from the wearable device in a process of tracking the wearable device by the unmanned flying robot.

18. The user terminal of claim 17, further comprising an output unit configured to output predetermined information in at least one of a visual method or an auditory method,
wherein the controller is configured to control the output unit so as to output notification information when reception of at least one of the positional information and the state information is impossible.

19. The user terminal of claim 18, wherein the controller is further configured to control the communication unit so as to receive photographing information acquired by photographing the wearer, and
wherein the controller is configured to control the output unit so as to output at least one of the state information, the positional information, and the photographing information.

20. The user terminal of claim 18, wherein the controller is configured to control the communication unit so as to transmit information on a preset area to the wearable device, and
wherein the controller is configured to control the output unit so as to output a notification message received from at least one of the unmanned flying robot and the wearable device when the positional information indicates that the wearable device is spaced apart from a boundary of the preset area by a predetermined distance.
